(19) United States
(12) Patent Application Publication
(10) Pub. No.: US 2026/0002079 A1
(43) Pub. Date: Jan. 1, 2026

(54) METHODS FOR PRODUCING PETROLEUM COKE

(71) Applicant: ExxonMobil Technology and Engineering Company, Spring, TX (US)

(72) Inventors: Jonathan M. GIESEKE, Pinehurst, TX (US); Geoffrey D. BOCK, Spring, TX (US); Fritz A. BERNATZ, Spring, TX (US)

(21) Appl. No.: 18/757,194

(22) Filed: Jun. 27, 2024

(51) Int. Cl. C10B 55/10; B01D 53/14; B01D 53/18; B01D 53/50; B01D 53/52; B01J 6/00

(52) U.S. Cl. CPC C10B 55/10; B01D 53/1406; B01D 53/145; B01D 53/1468; B01D 53/1481; B01D 53/18; B01D 53/501; B01D 53/52; B01J 6/008; B01D 2257/302; B01D 2257/304; B01D 2258/0283

(57) ABSTRACT

A method/system, which can be modified from the Flexicoking™ process/system, includes introducing a heavy petroleum feed into a fluidized bed in a reactor and converting the feed via a coking operation within the fluidized bed, producing an overhead stream with entrained coke fines from the reactor overhead and solid coke from the base of the reactor. The method includes injecting the solid coke into a fluidized bed in a burner and combusting the solid coke in the burner, producing hot coke particles. The method includes recirculating a portion of the hot coke particles to the fluidized bed in the reactor, discharging the remainder of the hot coke particles from the base of the burner and a flue gas from the burner overhead, and passing the flue gas and a caustic dispersion to a venturi scrubber to obtain a scrubbed flue gas. More petroleum coke can be produced from the method/system.

### FIELD

This disclosure relates generally to the field of petroleum coke and the coking process. More specifically, this disclosure relates to methods for producing petroleum coke.

### BACKGROUND

This section is intended to introduce various aspects of the art, which may be associated with aspects and embodiments of the present disclosure. This discussion is believed to assist in providing a framework to facilitate a better understanding of particular aspects and embodiments of the present disclosure. Accordingly, it should be understood that this section should be read in this light, and not necessarily as admissions of prior art.

In recent years, Flexicoking™ has become more prominent than fluid coking due to the Flexicoking™ system's ability to convert a majority or, in some cases, all of the produced coke from the reactor to a synthesis gas within the gasifier, resulting in a relatively small quantity of coke products (Flexicoke™) produced from the process. However, in some cases, it may be desirable to produce a higher amount of coke particles from the coking process for use in various applications, e.g., as proppant particles in hydraulic fracturing processes. However, modifying an existing Flexicoking™ system to increase coke production is not straight-forward and can be costly. There is a need for a cost-effective and efficient process for making coke particles based on a Flexicoke™ production system.

### SUMMARY

An aspect of the present disclosure provides a method. The method may comprise introducing a heavy petroleum feed into a fluidized bed in a reactor and converting the heavy petroleum feed to light hydrocarbon products and solid coke via a coking operation within the fluidized bed in the reactor, producing an overhead stream with entrained coke fines from the overhead of the reactor and solid coke from the base of the reactor. The method may also comprise injecting the solid coke into a fluidized bed in a burner and combusting at least a portion of the solid coke in the burner, thereby producing hot coke particles. The method may further comprise recirculating a first portion of the hot coke particles to the fluidized bed in the reactor, discharging a second portion of the hot coke particles from a base of the burner and a flue gas from an overhead of the burner, and passing the flue gas and a caustic dispersion to a venturi scrubber to obtain a scrubbed flue gas.

Another aspect of the present disclosure provides a method for modifying a coking system comprising a reactor, a heater producing a flue gas containing coke fines from an overhead of the heater, a venturi scrubber for removing coke fines from the flue gas, and a gasifier. The method may comprise removing the gasifier from service, converting the heater to a burner producing the flue gas, and injecting the flue gas and a caustic dispersion into the venturi scrubber to obtain a scrubbed flue gas.

Another aspect of the present disclosure provides a method for modifying a coking system comprising a reactor, a heater comprising a heater grid producing a flue gas from an overhead of the heater, and a gasifier. The method may comprise removing the gasifier from service and converting the heater to a burner by replacing the heater grid of the heater with a heater grid of the burner, where grid holes within the heater grid of the burner have a smaller diameter than grid holes within the heater grid of the heater. The method may also comprise modifying the reactor by reducing the number of cyclones within the reactor and adding an injection line for injecting a supplemental gas into the flue gas downstream of the burner.

These and other features and attributes of the disclosed aspects and embodiments of the present disclosure and their advantageous applications and/or uses will be apparent from the detailed description that follows.

### BRIEF DESCRIPTION OF THE DRAWINGS

To assist those of ordinary skill in the relevant art in making and using the subject matter described herein, reference is made to the appended drawings, where:

FIG. 1 is a schematic view of an exemplary process/system according to certain embodiments of this disclosure;

FIG. 2 is a process flow diagram of an exemplary method for producing petroleum coke according to aspects and embodiments described herein;

FIG. 3 is a process flow diagram of an exemplary method for modifying a coking system including a reactor, a heater producing a flue gas containing coke fines from an overhead of the heater, a venturi scrubber for removing coke fines from the flue gas, and a gasifier according to aspects and embodiments described herein; and

FIG. 4 is a process flow diagram of an exemplary method for modifying a coking system including a reactor, a heater including a heater grid producing a flue gas from an overhead of the heater, and a gasifier according to aspects and embodiments described herein.

It should be noted that the figures are merely examples of the present disclosure and are not intended to impose limitations on the scope of the present disclosure. Further, the figures are generally not drawn to scale, but are drafted for purposes of convenience and clarity in illustrating various aspects of the present disclosure.

### DETAILED DESCRIPTION

In the following detailed description section, the specific examples of the present disclosure are described in connection with preferred aspects and embodiments. However, to the extent that the following description is specific to one or more aspects or embodiments of the present disclosure, this is intended to be for exemplary purposes only and simply provides a description of such aspect(s) or embodiment(s). Accordingly, the present disclosure is not limited to the specific aspects and embodiments described below, but rather, includes all alternatives, modifications, and equivalents falling within the true spirit and scope of the appended claims.

At the outset, and for ease of reference, certain terms used in this application and their meanings as used in this context are set forth. To the extent a term used herein is not defined below, it should be given the broadest definition those skilled in the art have given that term as reflected in at least one printed publication or issued patent. Further, the present disclosure is not limited by the usage of the terms shown below, as all equivalents, synonyms, new developments, and terms or processes that serve the same or a similar purpose are considered to be within the scope of the present claims.

In this disclosure, a process may be described as comprising at least one “step.” It should be understood that each step is an action or operation that may be carried out once or multiple times in the process, in a continuous or discontinuous fashion. Unless specified to the contrary or the context clearly indicates otherwise, multiple steps in a process may be conducted sequentially in the order as they are listed, with or without overlapping with one or more other steps, or in any other order, as the case may be. In addition, one or more or even all steps may be conducted simultaneously with regard to the same or different batch of material. For example, in a continuous process, while a first step in a process is being conducted with respect to a raw material just fed into the beginning of the process, a second step may be carried out simultaneously with respect to an intermediate material resulting from treating the raw materials fed into the process at an earlier time in the first step. Preferably, the steps are conducted in the order described.

Unless otherwise indicated, all numbers indicating quantities in this disclosure are to be understood as being modified by the term “about” in all instances. It should also be understood that the precise numerical values used in the specification and claims constitute specific embodiments. Efforts have been made to ensure the accuracy of the data in the examples. However, it should be understood that any measured data inherently contains a certain level of error due to the limitation of the technique and/or equipment used for acquiring the measurement.

As used herein, the singular forms “a,” “an,” and “the” mean one or more when applied to any embodiment described herein. The use of “a,” “an,” and/or “the” does not limit the meaning to a single feature unless such a limit is specifically stated.

The terms “about” and “around” mean a relative amount of a material or characteristic that is sufficient to provide the intended effect. The exact degree of deviation allowable in some cases may depend on the specific context, e.g., ±1%, ±5%, ±10%, ±15%, etc. It should be understood by those of skill in the art that these terms are intended to allow a description of certain features described and claimed without restricting the scope of these features to the precise numerical ranges provided. Accordingly, these terms should be interpreted as indicating that insubstantial or inconsequential modifications or alterations of the subject matter described are considered to be within the scope of the disclosure.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

The phrase “at least one,” when used in reference to a list of one or more entities (or elements), should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently, “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the terms “example,” exemplary,” and “embodiment,” when used with reference to one or more components, features, structures, or methods according to the present disclosure, are intended to convey that the described component, feature, structure, or method is an illustrative, non-exclusive example of components, features, structures, or methods according to the present disclosure. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present disclosure.

The term “petroleum coke” refers to a final carbon-rich solid material that is derived from oil refining. More specifically, petroleum coke is the carbonization product of high-boiling hydrocarbon fractions that are obtained as a result of petroleum processing operations. Petroleum coke is produced within a coking unit via a thermal cracking process in which long-chain hydrocarbons are split into shorter-chain hydrocarbons. There are at least three main types of petroleum coke: delayed coke, fluid coke, and Flexicoke™. Each type of petroleum coke is produced using a different coking process; however, all three coking processes have the common objective of maximizing the yield of distillate products within a refinery by rejecting large quantities of carbon in the residue as petroleum coke.

Certain embodiments and features are described herein using a set of numerical upper limits and a set of numerical lower limits. It should be appreciated that ranges from any lower limit to any upper limit are contemplated unless otherwise indicated. All numerical values are “about”, “around,” or “approximately” the indicated value, and account for experimental errors and variations that would be expected by a person having ordinary skill in the art.

Fluid coke is a type of petroleum coke that is produced via a continuous-fluid-bed petroleum refining process, referred to as “fluid coking,” in which heavy petroleum feeds, typically the non-distillable residues from fractionation, are converted to lighter, more useful liquid products by thermal decomposition (or “coking”) at elevated reaction temperatures, e.g., typically around 450 to 700° C. on contacting hot coke particles. The fluid coking process is carried out using a fluid coking system including a large reactor vessel containing hot coke particles heated in a burner (described below), which are maintained in the fluidized condition at the appropriate reaction temperature, with steam injected at the bottom of the vessel and with the average direction of movement of the coke particles being downwards through the bed. In a conventional fluid coking system, the heavy oil feed is heated to a pumpable temperature, mixed with atomizing steam, and fed through multiple feed nozzles arranged at several successive levels in the reactor, usually referred to as “rings” since they are arranged around the periphery of the reactor at different, vertically-spaced intervals in the upper part of the reactor. Steam can be injected into a stripper section at the bottom of the reactor and passes upwards through the coke particles in the stripper as the coke particles descend from the main part of the reactor above. This also promotes fluidization of the coke particles in the bed. The feed liquid coats a portion of the coke particles in the fluidized bed and subsequently decomposes into layers of solid coke and lighter products which evolve as gas or vaporized liquid. The light hydrocarbon products of the coking (or thermal cracking) reactions vaporize, mix with the fluidizing steam, and pass upwardly through the fluidized bed into a dilute phase zone above the dense fluidized bed of coke particles. This mixture of vaporized hydrocarbon products formed in the coking reactions continues to flow upwardly, entraining some fine solid coke particles. Most of the entrained solid coke particles are separated from the gas phase by centrifugal force in one or more cyclones and are returned to the dense fluidized bed by gravity through the cyclone diplegs. The mixture of steam and hydrocarbon vapors from the reactor is subsequently discharged from the cyclone gas outlets into a scrubber section in a plenum located above the reaction section and separated from it by a partition. It is quenched in the scrubber section by contact with liquid descending over scrubber sheds. A pump-around loop can circulate condensed liquid to an external cooler and back to the top row of the scrubber section to provide cooling for the quench and condensation of the heaviest fraction of the liquid product. This heavy fraction is typically recycled to extinction by feeding back to the fluidized bed reaction zone.

In a conventional fluid coking system, the solid coke particles from the reactor, consisting essentially of carbon with lesser amounts of hydrogen, sulfur, nitrogen, and traces of vanadium, nickel, iron, and other elements derived from the feed, passes through the stripper and out of the reactor vessel to a burner where it is partly burned in a fluidized bed with air to raise its temperature from around 450 to around 700° C., after which a portion of the hot coke particles are recirculated to the fluidized bed reaction zone in the reactor to provide the heat for the coking reactions and to act as nuclei for the coke formation.

Flexicoke™ is a type of petroleum coke that is produced via the Flexicoking™ process, developed by ExxonMobil, which is a specialized fluid coking process that is operated in a unit including a reactor and a heater (as opposed to a burner), as well as a gasifier for gasifying at least a portion of the coke product by reaction with an air/steam mixture to form a low-BTU fuel gas (referred to as Flexigas™). The heater, in this case, is operated with an oxygen-depleted environment. The gasifier product gas, containing entrained coke particles, is returned to the heater to provide a portion of the reactor heat requirement. A return stream of coke sent from the gasifier to the heater provides the remainder of the heat requirement. Hot coke gas leaving the heater is used to generate high-pressure steam before being processed for cleanup. A coke product can be continuously removed from the reactor.

In recent years, Flexicoking™ has become more prominent than fluid coking due to the Flexicoking™ system's ability to convert a majority or, in some cases, all of the produced coke from the reactor to a synthesis gas within the gasifier, resulting in a relatively small quantity of coke products (Flexicoke™) produced from the process. However, in some cases, it may be desirable to produce a higher amount of coke particles from the coking process for use in various applications, e.g., as proppant particles in hydraulic fracturing processes. However, modifying an existing Flexicoking™ system to increase coke production is not straight-forward and can be costly. There is a need for a cost-effective and efficient process for making coke particles based on a Flexicoking™ system.

The present disclosure provides methods for producing petroleum coke using a new coking process/system that may or may not be converted from a Flexicoking™ process/system. A new coking system may be designed, engineered, and constructed to run the coking process of this disclosure. Alternatively, various modifications of an existing Flexicoking™ process/system can be made pursuant to this disclosure to obtain the coking system of this disclosure for running the coking processes of this disclosure. In particular, in various embodiments, the gasifier in a Flexicoking™ system may be removed from service. In various embodiments, the heater in the Flexicoking™ system may be converted to a burner with increased air supply to the burner compared to the heater. In such embodiments, the heater grid may be modified to include a smaller open area due to a reduction in gas to the burner. In addition, in such embodiments, the cyclones in the heater may be modified to perform efficiently with less gas and a coarser particle size distribution. In various embodiments, the cyclones in the reactor of the Flexicoking™ system may be modified to include more open area to prevent fouling, and lancing facilities may be added to address fouling in the cyclones. In various embodiments, the number of tertiary cyclones of the Flexicoking™ system may be reduced to account for the reduced gas flow in the system, and some of the tertiary cyclones may be removed if the new cyclones in the burner effectively remove a large amount of the coke fines.

In various embodiments of the process/system of this disclosure, a caustic may be supplied to the venturi scrubber receiving the flue gas from the heater (or burner after conversion) to remove sulfur oxides (SOₓ) from the flue gas. In various embodiments, a supplemental fuel gas may be combined with the flue gas from the burner upstream of one or more furnaces (e.g., low-BTU gas (“LBG”) furnaces), and/or, in specific embodiments, a supplement gas (which may comprise a fuel gas) may be combined with the flue gas from the burner upstream of the venturi scrubber.

Compared to conventional Flexicoking™ processes, the processes and systems of this disclosure can produce significantly larger quantity of petroleum coke with desired size, geometry and mechanical properties, e.g., 30 wt %, 40 wt %, 50 wt %, 60 wt %, 70 wt %, 80 wt %, 90 wt %, 100 wt %, 150 wt %, or even 200 wt %, more, compared to the weight of the Flexicoke™ produced from a Flexicoking™ system having a reactor and heater with similar dimensions. Moreover, a clean fuel gas low in sulfur can be produced in various embodiments of the process/system of this disclosure, which can be optionally combined with additional fuel gas and used as industrial fuel, improving the overall energy efficiency of the technology compared to the conventional Flexicoking™ process. Compared to a conventional fluid coking system, the process/system of this disclosure, particularly if converted from a Flexicoking™ system, can save a significant amount in capital investment by ingenious, low-cost modification that produces highly advantageous effects.

Various preferred embodiments of the processes/systems of this disclosure are described in greater detail below by referencing the non-limiting, illustrative drawings. Such examples are not intended to indicate that the process/system provided herein are to include every component shown in the drawings in every case, or that the process/system provided herein are limited to only the components shown in the drawings. Instead, the process/system may be adapted to fit the details of the particular implementation without departing from the scope of the present disclosure.

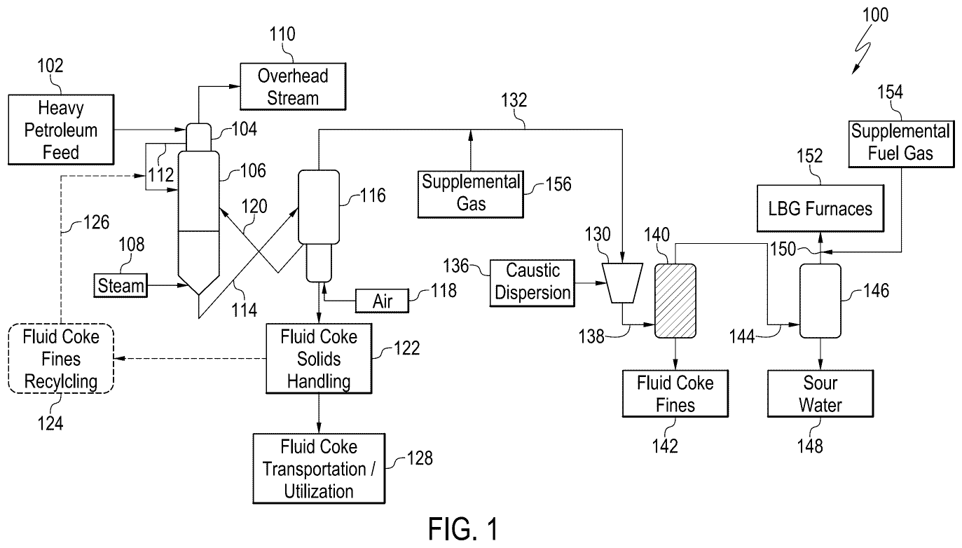

FIG. 1 is a schematic view of an exemplary process/system 100 according to certain embodiments of this disclosure. As shown in FIG. 1, a heavy petroleum feed 102 (e.g., vacuum residuum, atmospheric residuum, oil sands bitumen, heavy whole crudes, or the like) may be sprayed into a scrubber vessel 104 above a reactor 106 and then travel down to the feed nozzles of the reactor 106. The feed nozzles may be arranged at several successive levels in the reactor 106, usually referred to as “rings” since they are arranged around the periphery of the reactor 106 at different, vertically-spaced intervals in the upper part of the reactor 106, and the heavy petroleum feed 102 may be injected into a fluidized bed of hot coke particles within the reactor 106 through such feed nozzles. At the same time, optional steam 108 may be injected into an optional stripper section at the base of the reactor 106.

The temperature in the fluidized bed may be maintained at elevated reaction temperatures ranging from around 500° C. to around 700° C. by an incoming stream of hot coke particles in line 120 (described in greater detail below). In this range of temperatures, the heavy petroleum feed 102 may be converted to light hydrocarbon products (which evolve as gas or vaporized liquid) and layers of solid coke via coking (or thermal cracking) reactions. The solid coke may be deposited on the fluidized particles within the reactor 106, while the light hydrocarbon products may mix with the steam 108 and pass upwardly through the fluidized bed into a dilute phase zone above the fluidized bed. This mixture of vaporized hydrocarbon products may continue to flow upwardly through the dilute phase with the steam 108, entraining some amount of coke fines. At least a portion of the entrained coke fines may be separated from the gas phase by centrifugal force in one or more cyclones and may then be returned to the fluidized bed by gravity through the cyclone diplegs. In some embodiments (e.g., particularly for embodiments in which the reactor 106 was converted from a reactor of a Flexicoking™ system), such cyclones in the reactor 106 may be modified to include more open area to prevent fouling. In various embodiments, increasing the area (while still supplying enough velocity in the cyclones to remove coke particles) may be accomplished by reducing the number of cyclones (e.g., from 4 cyclones to 3 cyclones) and increasing the area within the cyclones, which will reduce fouling yet still render the cyclones effective at particle separation. In addition, lancing facilities may be added to address fouling in the cyclones. In various embodiments, this may include providing nozzles in the shell of the scrubber vessel 104 to allow on-line lancing of the cyclone outlet snout. Coke deposits that form in the snout during the run may be periodically removed by lancing to reduce pressure drop. In various embodiments, the nozzles may be positioned to permit insertion of a water lance into the cyclone outlet snout along its centerline and outside the area of impingement from the snout discharge stream. The vaporized hydrocarbon products may subsequently be discharged from the cyclone outlet snout into the scrubber vessel 104 and may then be quenched in the scrubber vessel 104 by contact with liquid descending over the scrubber sheds. Resulting overhead stream 110 may then be carried upward and out of the reactor 106. Meanwhile, heavy hydrocarbon materials mixed with coke fines may become trapped in a slurry trap within the reactor 106 and may then be recycled to the fluidized bed within the reactor 106 via line 112.

The solid coke (or at least a portion thereof) may continue to move towards the base of the reactor 106, and volatile materials trapped within the coke may be stripped off by the steam 108. As indicated by line 114, the resulting coke particles may be withdrawn from the reactor 106 and injected into a fluidized bed within a burner 116. An oxygen-containing gas (e.g., air, oxygen-enriched air, air-steam mixture, and the like) 118 may be injected into the burner, preferably in the vicinity of the bottom of the burner. In some embodiments (e.g., particularly for embodiments in which the burner 116 was previously utilized as a heater within a Flexicoking™ system), the heater grid of the burner 116 may be modified to include a smaller open area due to a reduction in gas to the burner 116. In various embodiments, such modification of the heater grid may include designing the heater grid with grid holes having a diameter of around 8 millimeters (mm) to around 12 mm (e.g., in some embodiments, around 10 mm) and a pressure differential (ΔP) that is around 35% to around 45% (e.g., in some embodiments, 40%) of the ΔP across the dense bed to achieve a fluidized bed. In addition, in such embodiments, the cyclones in the heater of a Flexicoking™ system may be modified to perform efficiently with less gas and a coarser particle size distribution. In various embodiments, to adjust the cyclones, the inlet gas velocity of the primary cyclone may be designed to be around 65 feet per second (ft/s) (20 m/s) to around 75 ft/s (23 m/s), and the inlet gas velocity of the secondary cyclones may be designed to be around 75 ft/s (23 m/s) to around 85 ft/s (26 m/s). In such embodiments, such inlet gas velocities may be achieved by modifying the cyclones in the heater of a Flexicoking™ system or by “blanking” existing cyclones such that the velocities are achieved in the online cyclones.

Within the fluidized bed in the burner 116, the coke particles is partly burned to release thermal energy, thereby maintaining the temperature in the burner in a range from around 550° C. to around 700° C., for example. A portion of the hot coke particles in the burner is recirculated to the fluidized bed within the reactor 106 via line 120 to provide the heat for the coking reactions and to act as nuclei for the coke formation within the reactor 106. The remaining coke particles may be output from the burner 116 and sent to equipment or facilities that are designed for coke solids handling, as indicated by box 122. In some embodiments, at least a portion of such coke may then be recycled to the reactor 106 (e.g., potentially via combination with the recycled heavy hydrocarbon materials and coke fines from the slurry trap), as indicated by box 124 and line 126. Moreover, in various embodiments, the remaining coke particles may be transported to one or more desired destinations to be utilized for one or more desired applications, as indicated by box 128. In various embodiments, such desired destinations may include one or more hydraulic fracturing locations, and the coke particles may be utilized as low-density proppant for one or more corresponding hydraulic fracturing operations.

The flue gas from the burner 116 may be passed to a venturi scrubber 130 via line 132. The flue gas in line 132 may be optionally combined with supplemental gas 134 (e.g., natural gas, hydrogen, nitrogen, mixtures thereof, and/or other suitable type(s) of supplemental gas) to increase gas velocity at the venturi scrubber where desired, and the BTU value of the overhead gas that can be used in combustion applications. For example, in some embodiments, the BTU values may be increased from around 20 to 40 British thermal units per standard cubic foot (btu/scf) to around 110 to 130 btu/scf via the addition of the supplemental gas 134. Moreover, according to the embodiment shown in FIG. 1, the combination of the supplemental gas 134 with the flue gas from the burner 116 upstream of the venturi scrubber 130 may be used to increase the velocity of the flue gas as it enters the venturi scrubber 130.

At the venturi scrubber 130, it may undergo a sulfur oxide (SOₓ) (e.g., SO₂ and/or SO₃) removal process. In other words, in various embodiments, the venturi scrubber 130 may be effectively utilized as a wet gas scrubber. As part of this process, a caustic dispersion 136 may be injected into the venturi scrubber 130. Such caustic dispersion 136 may be a solution, a suspension, or an emulsion of a caustic in a liquid, preferably an aqueous solution. The caustic may include but is not limited to sodium hydroxide (NaOH), potassium hydroxide (KOH), sodium carbonate (Na₂CO₃), or the like. In some embodiments, water and concentrated caustic dispersion may be simultaneously injected into the venturi scrubber 130 to obtain the caustic dispersion 136. In various embodiments, an adjustable stream of the caustic dispersion 136 may be injected into a water stream to form a diluted caustic stream. The diluted caustic stream may then be injected into the venturi scrubber 130 to scrub the flue gas of coke fines and SOₓ. The venturi scrubber effluent may be a liquid/gas/solid mixture, which may be separated to obtain a liquid scrubber stream and a scrubbed flue gas stream. The liquid scrubber stream may be monitored for pH by a meter or periodic analysis. The measured pH may be used to adjust the flow rate of the adjustable stream of caustic dispersion, so that the pH of the liquid scrubber stream is maintained close to 7.

In some embodiments (e.g., particularly for embodiments in which the venturi scrubber 130 was previously utilized within a Flexicoking™ system), the open area in the throat of the venturi scrubber 130 may be modified to maintain sufficient velocity for gas/liquid contact to remove SOₓ from the flue gas. In various embodiments, a target velocity of around 175 ft/s (53 m/s) to around 225 ft/s (69 m/s) (e.g., in some embodiments, 200 ft/s (61 m/s)) into the venturi scrubber 130 may be maintained for adequate gas/liquid contact, and a ratio of around 2 moles (“mols”) of caustic to around 1 mol of SOₓ may also be maintained.

As indicated by line 138, the resulting scrubbed flue gas (and optionally a wash water stream) may then be passed through a wash tower 140, where coke fines 142 may be separated from the flue gas to obtain a washed flue gas. As indicated by line 144, the washed flue gas may then be passed through an absorber 146 for the removal of hydrogen sulfide (H₂S), thus producing separate streams of sour water 148 (i.e., water containing H₂S) and a purified flue gas in line 150. As indicated by line 150, the purified flue gas may then be sent to one or more furnaces 152 (e.g., LBG furnaces) for use as a low-BTU gas fuel. In some embodiments, a supplemental fuel gas 154 (e.g., natural gas, hydrogen, and mixtures thereof) may be injected into line 150 to obtain a mixture fuel gas stream having a higher BTU than the washed flue gas, which is then fed into the furnaces or any other type of furnaces for combustion. Additionally or alternatively, the supplemental fuel gas 154 may be directly fed into the furnaces 152 or any other type of furnaces directly alongside the purified flue gas. the furnaces 152 may incorporate hydrogen and/or methane addition facilities to accommodate the lower BTU gas produced by the process/system 100 as opposed to the previous Flexicoking™ system.

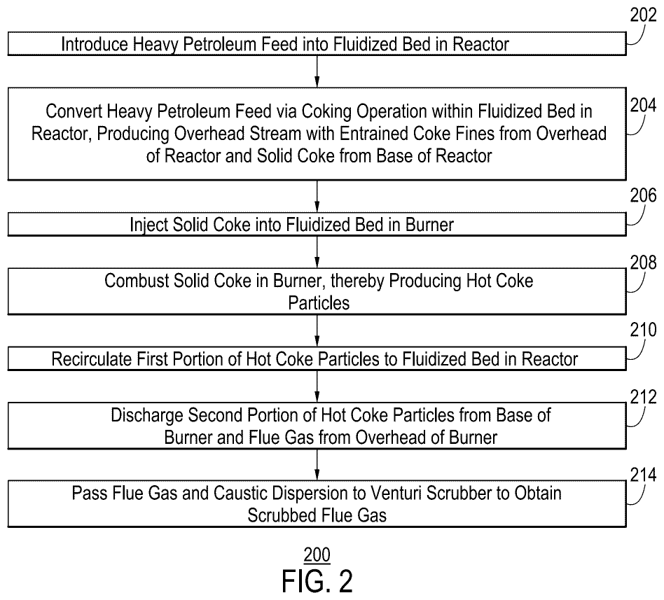

Turning to details of exemplary methods according to the present disclosure, FIG. 2 is a process flow diagram of an exemplary method 200 for producing petroleum coke according to aspects and embodiments described herein.

The exemplary method 200 may begin at block 202, at which a heavy petroleum feed may be introduced into a fluidized bed in a reactor. At block 204, the heavy petroleum feed may be converted via a coking operation within the fluidized bed in the reactor, producing an overhead stream with entrained coke fines from the overhead of the reactor and solid coke from the base of the reactor.

At block 206, the solid coke may be injected into a fluidized bed in a burner. In some embodiments, the heater grid of the burner may have grid holes with a diameter of around 8 mm to around 12 mm. In some embodiments, the primary cyclone of the burner may have an inlet gas velocity of around 20 m/s to around 23 m/s, and the secondary cyclone(s) of the burner may have an inlet gas velocity of around 23 m/s to around 26 m/s.

At block 208, at least a portion of the solid coke may be combusted in the burner, thereby producing hot coke particles. In various embodiments, the solid coke may be burned at temperatures ranging from 550° C. to 650° C. within the fluidized bed in the burner.

At block 210, a first portion of the hot coke particles may be recirculated to the fluidized bed in the reactor. At block 212, a second portion of the hot coke particles may be discharged from the base of the burner (e.g., to a product coke silo), and a flue gas may be discharged from an overhead of the burner.

At block 214, the flue gas and a caustic dispersion may be passed to a venturi scrubber to obtain a scrubbed flue gas. In some embodiments, a target velocity of around 53 m/s to around 69 m/s may be maintained into the venturi scrubber for adequate gas/liquid contact. In some embodiments, the caustic dispersion may be a solution, a suspension, or an emulsion of a caustic in a liquid, preferably an aqueous solution. The caustic may include but is not limited to NaOH, KOH, Na₂CO₃, or the like. In some embodiments, water and concentrated caustic dispersion may be simultaneously injected into the venturi scrubber to obtain the caustic dispersion. Moreover, in various embodiments, an adjustable stream of the caustic dispersion may be injected into a water stream to form a diluted caustic stream. The diluted caustic stream may then be injected into the venturi scrubber to scrub the flue gas of coke fines and SO₂. The venturi scrubber effluent may be a liquid/gas/solid mixture, which may be separated to obtain a liquid scrubber stream and a scrubbed flue gas stream. The liquid scrubber stream may be monitored for pH by a meter or periodic analysis. The measured pH may be used to adjust the flow rate of the adjustable stream of caustic dispersion, so that the pH of the liquid scrubber stream is maintained close to 7.

In some embodiments, the method 200 may also include injecting a supplemental gas into the flue gas after block 212 and before block 214. The supplemental gas may include but is not limited to natural gas, hydrogen, nitrogen, or the like, or mixtures thereof.

In some embodiments, the method 200 may also include: (1) passing the scrubbed flue gas through a wash tower to remove coke fines from the scrubbed flue gas to obtain a washed flue gas; (2) passing the washed flue gas through an absorber to remove hydrogen sulfide from the washed flue gas to obtain a purified flue gas; and (3) supplying the purified flue gas to one or more furnaces, such as LBG furnaces. In such embodiments, a supplemental fuel gas may be injected into the purified flue gas after block 214 and before step (3), or a supplemental fuel gas may be injected into the furnace(s) simultaneously with step (3). The supplemental fuel gas may include but is not limited to natural gas and/or hydrogen.

In some embodiments, the method 200 may also include modifying a Flexicoking™ system. This may include removing the gasifier of the Flexicoking™ system from service. Additionally or alternatively, this may include converting the heater of the Flexicoking™ system to the burner by replacing the heater grid of the heater with the heater grid of the burner, where the grid holes within the heater grid of the burner have a smaller diameter than grid holes within the heater grid of the heater. Additionally or alternatively, this may include modifying the reactor by reducing the number of cyclones within the reactor. Additionally or alternatively, this may include adding an injection line for injecting a supplemental gas or supplemental fuel gas into the flue gas downstream of the burner. Additionally or alternatively, this may include injecting a flue gas and a caustic dispersion into the venturi scrubber to obtain a scrubbed flue gas. Additionally or alternatively, this may include reducing the number of tertiary cyclones within the system to account for reduced gas flow in the process/system of this disclosure compared to a conventional Flexicoking™ process/system.

Those skilled in the art will appreciate that the exemplary method 200 of FIG. 2 is susceptible to modification without altering the technical effect provided by the present disclosure. For example, in some embodiments, one or more blocks may be omitted from the method 200, and/or one or more blocks may be added to the method 200. In practice, the exact manner in which the method 200 is implemented will depend at least in part on the details of the specific implementation.

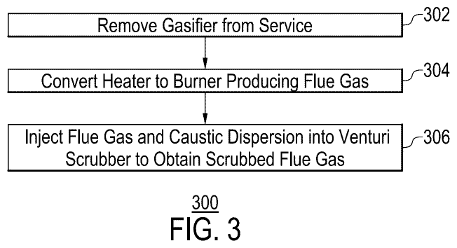

FIG. 3 is a process flow diagram of an exemplary method 300 for modifying a coking system including a reactor, a heater producing a flue gas containing coke fines from an overhead of the heater, a venturi scrubber for removing coke fines from the flue gas, and a gasifier according to aspects and embodiments described herein. The exemplary method 300 may begin at block 302, at which the gasifier may be removed from service. At block 304, the heater may be converted to a burner producing the flue gas. In some embodiments, this is achieved by replacing the heater grid of the heater with a heater grid of the burner, where grid holes within the heater grid of the burner have a smaller diameter than grid holes within the heater grid of the heater.

At block 306, the flue gas and a caustic dispersion are injected into the venturi scrubber to obtain a scrubbed flue gas. In some embodiments, a supplemental gas is also injected into the flue gas upstream of the venturi scrubber. In other embodiments, a supplemental fuel gas is injected into the scrubbed flue gas downstream of the venturi scrubber. In either embodiment, the supplemental gas or supplemental fuel gas may include but is not limited to natural gas and/or hydrogen.

Those skilled in the art will appreciate that the exemplary method 300 of FIG. 3 is susceptible to modification without altering the technical effect provided by the present disclosure. For example, in some embodiments, one or more blocks may be omitted from the method 300, and/or one or more blocks may be added to the method 300. In practice, the exact manner in which the method 300 is implemented will depend at least in part on the details of the specific implementation.

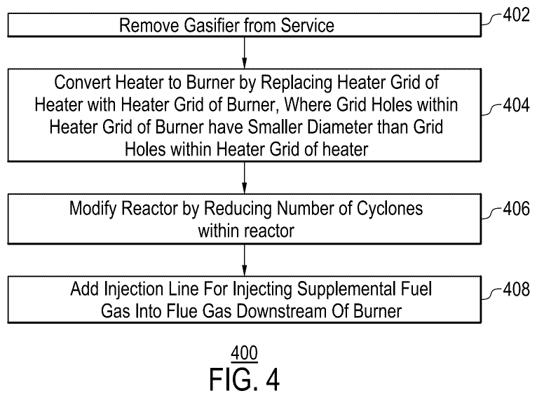

FIG. 4 is a process flow diagram of an exemplary method 400 for modifying a coking system including a reactor, a heater including a heater grid producing a flue gas from an overhead of the heater, and a gasifier according to aspects and embodiments described herein. The exemplary method 400 may begin at block 402, at which the gasifier may be removed from service.

At block 404, the heater may be converted to a burner by replacing the heater grid of the heater with a heater grid of the burner, where the grid holes within the heater grid of the burner may have a smaller diameter than the grid holes within the heater grid of the heater. In various embodiments, converting the heater to the burner may also include modifying a primary cyclone such that an inlet gas velocity of the primary cyclone is 65 ft/s (20 m/s) to 75 ft/s (23 m/s) and modifying one or more secondary cyclones such that an inlet gas velocity of the secondary cyclone(s) is 75 ft/s (23 m/s) to 85 ft/s (26 m/s). Moreover, in various embodiments, the grid holes within the heater grid of the burner may have a diameter of around 8 mm to around 12 mm.

At block 406, the reactor may be modified by reducing the number of cyclones within the reactor. In some embodiments, the number of cyclones may be reduced from four cyclones to three cyclones.

At block 408, an injection line may be added for injecting a supplemental fuel gas into the flue gas downstream of the burner. In various embodiments, the supplemental fuel gas may include natural gas and/or hydrogen. In some embodiments, the injection line is added upstream of one or more furnaces of the system.

In some embodiments, the coking system also includes a venturi scrubber for removing coke fines from the flue gas. In such embodiments, the method 400 may further include injecting a caustic dispersion into the venturi scrubber to obtain a scrubbed flue gas. Moreover, in some embodiments, a supplemental gas may be injected into the flue gas upstream of the venturi scrubber.

In addition, in some embodiments, the method 400 may further include reducing the number of tertiary cyclones to account for reduced gas flow in the modified coking system. Additionally or alternatively, in some embodiments, the method 400 may further include incorporating one or more hydrogen addition facilities and/or one or more methane addition facilities into the furnace(s) of the system to accommodate the lower BTU gas produced by the modified coking system.

The modifications to an existing Flexicoking™ process/system as described in this description, such as modification of the reactor, the heater, the venturi scrubber, and the addition of caustic dispersion to the venturi scrubber, requires much lower capital investments than converting the Flexicoking™ process/system into a conventional fluid coking system or building a grassroot conventional fluid coking system. Yet the thus modified process/system is capable of producing substantially higher quantity, e.g., from 30 wt %, 40 wt %, 50 wt %, to 60 wt %, 70 wt %, 80 wt %, 90 wt %, 100 wt %, to 120 wt %, 140 wt %, 150 wt %, to 160 wt %, 180 wt %, 200 wt %, more, or greater quantity of, petroleum coke compared to the Flexicoking™ process/system, which is comparable to or better than a conventional fluid coking process/system. Moreover, the modifications of this disclosure has the added advantages of producing a purified flue gas that can be conveniently used a fuel gas, e.g., in a petrochemical plant, compared to the conventional fluid coke process. The petroleum coke product produced from the process/system of this closure advantageously have the density, roundness, and strength suitable for proppants used in fracturing fluids for hydraulic fracturing operations.

In various embodiments, the resulting modified coking system may produce at least twice as much petroleum coke as the unmodified system would have produced from the same heavy petroleum feed. This is particularly advantageous for embodiments in which the petroleum coke product is to be utilized as a low-density proppant for hydraulic fracturing operations.

Those skilled in the art will appreciate that the exemplary method 400 of FIG. 4 is susceptible to modification without altering the technical effect provided by the present disclosure. For example, in some embodiments, one or more blocks may be omitted from the method 400, and/or one or more blocks may be added to the method 400. In practice, the exact manner in which the method 400 is implemented will depend at least in part on the details of the specific implementation.

This disclosure can include one or more of the following non-limiting aspects and embodiments:

A1. A method, comprising: (I) introducing a heavy petroleum feed into fluidized bed in a reactor; (II) converting the heavy petroleum feed to light hydrocarbon products and solid coke via a coking operation within the fluidized bed in the reactor, producing an overhead stream with entrained coke fines from an overhead of the reactor and solid coke from a base of the reactor; (III) injecting the solid coke into fluidized bed in a burner; (IV) combusting at least a portion of the solid coke in the burner, thereby producing hot coke particles; (V) recirculating a first portion of the hot coke particles to the fluidized bed in the reactor; (VI) discharging a second portion of the hot coke particles from a base of the burner (e.g., to a product coke silo) and a flue gas from an overhead of the burner; and (VII) passing the flue gas and a caustic dispersion to a venturi scrubber to obtain a scrubbed flue gas.

A2. The method of A1, further comprising, after step (VI) and before step (VII): (VIII) injecting a supplemental gas into the flue gas.

A3. The method of A2, wherein the supplemental gas comprises natural gas and/or hydrogen.

A4. The method of any of A1 to A3, wherein the solid coke is burned at temperatures ranging from 550° C. to 650° C. within the fluidized bed in the burner.

A5. The method of any of A1 to A4, wherein a heater grid of the burner has grid holes with a diameter of 8 mm to 12 mm.

A6. The method of any of A1 to A5, wherein a primary cyclone of the burner has an inlet gas velocity of 20 m/s to 23 m/s and at least one secondary cyclone of the burner has an inlet gas velocity of 23 m/s to 26 m/s.

A7. The method of any of A1 to A6, wherein a target velocity of 53 m/s to 69 m/s is maintained into the venturi scrubber for adequate gas/liquid contact.

A8. The method of any of A1 to A7, further comprising: (IX) passing the scrubbed flue gas through a wash tower to remove coke fines from the scrubbed flue gas to obtain a washed flue gas; (X) passing the washed flue gas through an absorber to remove hydrogen sulfide from the washed flue gas to obtain a purified flue gas; and (XI) supplying the purified flue gas to a furnace (e.g., an LBG furnace).

A9. The method of A8, further comprising: (XII) injecting, after step (VII) and before step (XI), a supplemental fuel gas into the purified flue gas, and/or injecting the supplemental fuel gas into the furnace simultaneously with step (XI).

A10. The method of A9, wherein the supplemental fuel gas comprises natural gas and/or hydrogen.

A11. The method of any of A1 to A10, further comprising modifying a Flexicoking™ system.

A12. The method of A11, comprising removing a gasifier of the Flexicoking™ system from service.

A13. The method of A11, comprising converting a heater of the Flexicoking™ system to the burner by replacing a heater grid of the heater with the heater grid of the burner, wherein the grid holes within the heater grid of the burner have a smaller diameter than grid holes within the heater grid of the heater.

A14. The method of A1, comprising: introducing the heavy petroleum feed into a scrubber vessel above the reactor such that the heavy petroleum feed travels down to feed nozzles of the reactor and is injected into the fluidized bed in the reactor through the feed nozzles; injecting steam into a stripper section at the base of the reactor; maintaining a temperature of the fluidized bed at 500° C. to 700° C., such that the heavy petroleum feed is converted to light hydrocarbon products and solid coke via the coking operation, wherein the light hydrocarbon products mix with the injected steam to form vaporized hydrocarbon products that pass upwardly through the fluidized bed and through a dilute phase zone above the fluidized bed, producing the overhead stream with the entrained coke fines; separating at least a portion of the entrained coke fines from the overhead stream by centrifugal force in at least one cyclone; returning the separated coke fines to the fluidized bed, while discharging the overhead stream, from the scrubber vessel; stripping at least a portion of volatile materials from the solid coke via interaction with the injected stream as the solid coke travels toward the base of the reactor; injecting the solid coke into the fluidized bed in the burner; combusting the portion of the solid coke in the burner, producing the hot coke particles, wherein a heater grid of the burner has grid holes with a diameter of 8 mm to 12 mm, and wherein a primary cyclone of the burner has an inlet gas velocity of 20 m/s to 23 m/s and at least one secondary cyclone of the burner has an inlet gas velocity of 23 m/s to 26 m/s; recirculating the first portion of the hot coke particles to the fluidized bed in the reactor to provide heat for the coking operation; discharging the second portion of the hot coke particles from the base of the burner (e.g., to the product coke silo) and the flue gas from the overhead of the burner; and passing the flue gas and the caustic dispersion to the venturi scrubber to obtain the scrubbed flue gas, wherein a target velocity of 53 m/s to 69 m/s is maintained into the venturi scrubber for adequate gas/liquid contact.

B1. A method for modifying a coking system comprising a reactor, a heater producing a flue gas containing coke fines from an overhead of the heater, a venturi scrubber for removing coke fines from the flue gas, and a gasifier, the method comprising: removing the gasifier from service; converting the heater to a burner producing the flue gas; and injecting the flue gas and a caustic dispersion into the venturi scrubber to obtain a scrubbed flue gas.

B2. The method of B1, comprising converting the heater to the burner by replacing a heater grid of the heater with a heater grid of the burner, wherein grid holes within the heater grid of the burner have a smaller diameter than grid holes within the heater grid of the heater.

B3. The method of B1 or B2, further comprising injecting a supplemental gas into the flue gas upstream of the venturi scrubber.

B4. The method of B3, wherein the supplemental gas comprises natural gas and/or hydrogen.

B5. The method of any of B1 to B4, further comprising injecting a supplemental fuel gas into the scrubbed flue gas downstream of the venturi scrubber.

B6. The method of B5, wherein the supplemental fuel gas comprises natural gas and/or hydrogen.

C1. A method for modifying a coking system comprising a reactor, a heater comprising a heater grid producing a flue gas from an overhead of the heater, and a gasifier, the method comprising: removing the gasifier from service; converting the heater to a burner by replacing the heater grid of the heater with a heater grid of the burner, wherein grid holes within the heater grid of the burner have a smaller diameter than grid holes within the heater grid of the heater; modifying the reactor by reducing a number of cyclones within the reactor; and adding an injection line for injecting a supplemental fuel gas into the flue gas downstream of the burner.

C2. The method of C1, wherein the supplemental fuel gas comprises natural gas and/or hydrogen.

C3. The method of C1 or C2, wherein the coking system further comprises a venturi scrubber for removing coke fines from the flue gas, and the method further comprises injecting a caustic dispersion into the venturi scrubber to obtain a scrubbed flue gas.

C4. The method of C3, further comprising injecting a supplemental gas into the flue gas upstream of the venturi scrubber.

C5. The method of any of C1 to C4, comprising adding the injection line upstream of furnace of the coking system.

C6. The method of any of C1 to C5, comprising reducing a number of tertiary cyclones within the system to account for reduced gas flow in the modified coking system.

While the embodiments described herein are well-calculated to achieve the advantages set forth, it will be appreciated that such embodiments are susceptible to modification, variation, and change without departing from the spirit thereof. In other words, the particular embodiments described herein are illustrative only, as the teachings of the present disclosure may be modified and practiced in different but equivalent manners apparent to those skilled in the art having the benefit of the teachings herein. Moreover, the systems and methods illustratively disclosed herein may suitably be practiced in the absence of any element that is not specifically disclosed herein and/or any optional element disclosed herein. While compositions and methods are described in terms of “comprising” or “including” various components or steps, the compositions and methods can also “consist essentially of” or “consist of” the various components and steps. Indeed, the present disclosure includes all alternatives, modifications, and equivalents falling within the true spirit and scope of the appended claims.

What is claimed is:

1. A method, comprising:
(I) introducing a heavy petroleum feed into a fluidized bed in a reactor;
(II) converting the heavy petroleum feed via a coking operation within the fluidized bed in the reactor, producing an overhead stream with entrained coke fines from an overhead of the reactor and solid coke from a base of the reactor;
(III) injecting the solid coke into a fluidized bed in a burner;
(IV) combusting a portion of the solid coke in the burner, thereby producing hot coke particles;
(V) recirculating a first portion of the hot coke particles to the fluidized bed in the reactor;
(VI) discharging a second portion of the hot coke particles from a base of the burner and a flue gas from an overhead of the burner; and
(VII) passing the flue gas and a caustic dispersion to a venturi scrubber to obtain a scrubbed flue gas.

2. The method of claim 1, further comprising, after step (VI) and before step (VII):
(VIII) injecting a supplemental gas into the flue gas.

3. The method of claim 2, wherein the supplemental gas comprises natural gas and/or hydrogen.

4. The method of claim 1, wherein the solid coke is burned at temperatures ranging from 550 degrees Celsius (“° C.”) to 650° C. within the fluidized bed in the burner.

5. The method of claim 1, wherein a heater grid of the burner has grid holes with a diameter of from 8 millimeters (“mm”) to 12 mm.

6. The method of claim 1, wherein a primary cyclone of the burner has an inlet gas velocity of from 20 meters per second (“m/s”) to 23 m/s and at least one secondary cyclone of the burner has an inlet gas velocity of from 23 m/s to 26 m/s.

7. The method of claim 1, wherein a target velocity of from 53 m/s to 69 m/s is maintained into the venturi scrubber for adequate gas/liquid contact.

8. The method of claim 1, further comprising:
(IX) passing the scrubbed flue gas through a wash tower to remove coke fines from the scrubbed flue gas to obtain a washed flue gas;
(X) passing the washed flue gas through an absorber to remove hydrogen sulfide from the washed flue gas to obtain a purified flue gas; and
(XI) supplying the purified flue gas to a furnace.

9. The method of claim 8, further comprising:
(XII) injecting, after step (VII) and before step (XI), a supplemental fuel gas into the purified flue gas, and/or injecting the supplemental fuel gas into the furnace simultaneously with step (XI).

10. The method of claim 9, wherein the supplemental fuel gas comprises natural gas and/or hydrogen.

11. The method of claim 1, further comprising modifying a Flexicoking™ system to obtain the reactor and/or the burner.

12. The method of claim 11, comprising removing a gasifier of the Flexicoking™ system from service.

13. The method of claim 11, comprising converting a heater of the Flexicoking™ system to the burner by replacing a heater grid of the heater with the heater grid of the burner, wherein the grid holes within the heater grid of the burner have a smaller diameter than grid holes within the heater grid of the heater.

14. A method for modifying a coking system comprising a reactor, a heater producing a flue gas containing coke fines from an overhead of the heater, a venturi scrubber for removing coke fines from the flue gas, and a gasifier, the method comprising:
removing the gasifier from service;
converting the heater to a burner producing the flue gas; and
injecting the flue gas and a caustic dispersion into the venturi scrubber to obtain a scrubbed flue gas.

15. The method of claim 14, comprising converting the heater to the burner by replacing a heater grid of the heater with a heater grid of the burner, wherein grid holes within the heater grid of the burner have a smaller diameter than grid holes within the heater grid of the heater.

16. The method of claim 14, further comprising injecting a supplemental gas into the flue gas upstream of the venturi scrubber.

17. The method of claim 16, wherein the supplemental gas comprises natural gas and/or hydrogen.

18. The method of claim 14, further comprising injecting a supplemental fuel gas into the scrubbed flue gas downstream of the venturi scrubber.

19. The method of claim 18, wherein the supplemental fuel gas comprises natural gas and/or hydrogen.

20. A method for modifying a coking system comprising a reactor, a heater comprising a heater grid producing a flue gas from an overhead of the heater, and a gasifier, the method comprising:
removing the gasifier from service;
converting the heater to a burner by replacing the heater grid of the heater with a heater grid of the burner, wherein grid holes within the heater grid of the burner have a smaller diameter than grid holes within the heater grid of the heater;
modifying the reactor by reducing a number of cyclones within the reactor; and
adding an injection line for injecting a supplemental fuel gas into the flue gas downstream of the burner.

21. The method of claim 20, wherein the supplemental fuel gas comprises natural gas and/or hydrogen.

22. The method of claim 20, wherein the coking system further comprises a venturi scrubber for removing coke fines from the flue gas, and the method further comprises injecting a caustic dispersion into the venturi scrubber to obtain a scrubbed flue gas.

23. The method of claim 22, further comprising injecting a supplemental gas into the flue gas upstream of the venturi scrubber.

24. The method of claim 20, comprising adding the injection line upstream of a furnace receiving a purified flue gas obtained from the flue gas stream.

25. The method of claim 20, comprising reducing a number of tertiary cyclones within the system to account for reduced gas flow in the modified coking system.
